(19) United States
(12) Patent Application Publication
(10) Pub. No.: US 2021/0390562 A1
(43) Pub. Date: Dec. 16, 2021

(54) SYSTEM AND METHOD FOR ANALYZING AND SCORING BUSINESSES AND CREATING CORRESPONDING INDICES

(71) Applicant: Bitvore Corp., Los Angeles, CA (US)

(72) Inventors: Mirella Reznic, Irvine, CA (US); Anthony Gullotta, Carlsbad, CA (US); Todd A. Cass, San Francisco, CA (US); Greg Bolcer, Yorba Linda, CA (US); Steve Henning, Mission Viejo, CA (US)

(21) Appl. No.: 16/897,563

(22) Filed: Jun. 10, 2020

(51) Int. Cl. G06Q 30/02; G06Q 40/02; G06F 16/906; G06F 40/30

(52) U.S. Cl. CPC G06Q 30/0201; G06F 40/30; G06F 16/906; G06Q 40/025

(57) ABSTRACT

Systems and methods are provided for determining a sentiment score for an article, tagging the article with an entity and one or more of a plurality of signals, determining a daily sentiment score according the entity, and determining an average sentiment score according the daily sentiment score and a predetermined time period. System and methods are provided for assessing components of Growth and Risk calculations via sub-indices and their resulting growth and risk scores at an entity or industry level.

### FIELD

Aspects of the present disclosure relate to the creation of business indices which include, but are not limited to, analysis and scoring. More specifically, certain embodiments of the disclosure relate to a system and method for scoring companies which is then embodied in business indices.

### BACKGROUND

Conventional approaches for scoring businesses and embodying the resulting analysis and scoring in corresponding indices are traditionally limited to analyzing quantitative data, with little or no ongoing measure of qualitative (unstructured) data.

Further limitations and disadvantages of conventional and traditional approaches includes: static point-in-time results, single-dimensional factor analysis and high costs (limiting the approach for smaller to mid-sized firms)

### BRIEF SUMMARY

A system and/or method are provided for analyzing and scoring businesses and then embodying those results in corresponding indices as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 illustrates tagging and sentiment scoring of an article, in accordance with an example embodiment of the disclosure.

FIG. 2 is table of risk signals, in accordance with an example embodiment of the disclosure.

FIG. 3 illustrates the component indices of a risk index, in accordance with an example embodiment of the disclosure.

FIG. 4 is table of growth signals, in accordance with an example embodiment of the disclosure.

FIG. 5 illustrates the component indices of a growth index, in accordance with an example embodiment of the disclosure.

FIG. 6 illustrates the component indices of an ESG index along with a table of signals corresponding to each ESG component index, in accordance with an example embodiment of the disclosure.

FIG. 7 illustrates a visualization in a system for analyzing and scoring businesses and then embodying those results in corresponding indices, in accordance with an example embodiment of the disclosure.

FIG. 8 is a flow diagram of a process for scoring business indices, in accordance with an example embodiment of the disclosure.

### DETAILED DESCRIPTION

By the systems and methods disclosed herein, unstructured data (including but not limited to text) is aggregated from various sources and operations on the resulting dataset(s) such as normalization and other transformations. These operations produce analytics and other results that can be integrated into various workflows. By way of example and without limitation, the analytics and other results may be used for credit risk monitoring and surveillance, market forecasts for particular companies and industries, stock portfolio selection and monitoring, finding potential customers, and performing due diligence on potential customers and other third parties. Risk and Growth scores/indices may be derived purely from unstructured data or a combination of structured and unstructured data.

Risk and Growth scores/indices are not limited to analyzing quantitative data, static point-in-time results, and single-dimensional factor analysis. Rather, Risk and Growth scores/indices as disclosed herein may utilize an ongoing measure of qualitative (unstructured) data.

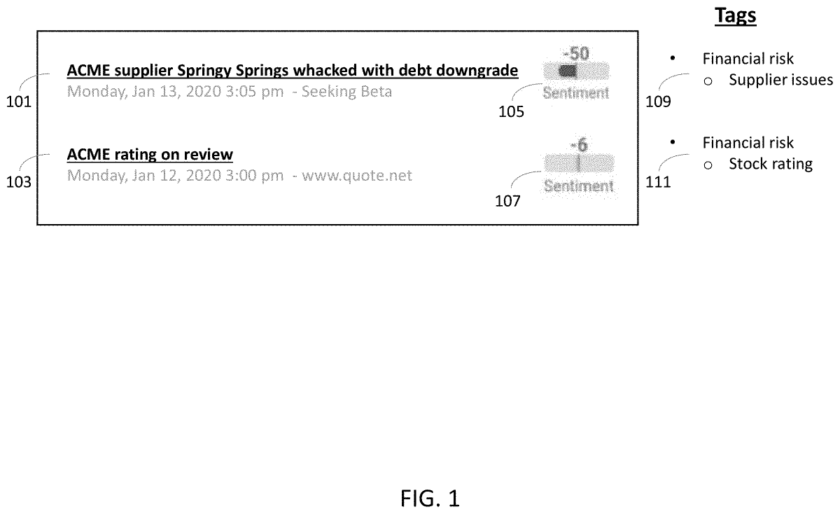

FIG. 1 illustrates tagging and sentiment scoring of an article 101, in accordance with an example embodiment of the disclosure. The word article is used in this specification/disclosure by way of example and not limitation, and references to “article” herein can be generalized to mean information or data. The article 101 is one of a plurality of articles 101, 103 published on a particular day. The scoring system disclosed herein may comprise a non-transitory computer readable medium (e.g., ROM, flash memory and/or a disk drive) having stored thereon software instructions. When performed by a processor, the software instructions are operable to determine a sentiment score for each article and tag an article with an entity. Entities (e.g., companies, markets, and/or people) may be tagged as an aspect of each article as a whole or as an aspect of each sentence of an article.

Deriving company sentiment starts with a sentence-by-sentence analysis of a news article 101 and/or 103. A sentence may be parsed into verbs, nouns, modifiers, and other language components that are assigned a polarity. Modifiers may be assessed for polarity and directionality, and the overall sentence direction may be assessed through a sequencing of words. The relative magnitude of the sentence sentiment may be assigned according to algorithms, such as artificial intelligence algorithms, that are trained over a range of content. The overall sentiment score for the article 105 and 107 may be based on an average of the sentence sentiments within the article.

A daily sentiment score may be based on one or more sentiment scores corresponding to the one or more articles published on the particular day. Each article may be tagged with an entity, such as a company or other entity. For example, if articles 101 and 103 are tagged with the ACME Company, the daily sentiment score for the ACME Company would be based on at least the sentiment 105 and 107 of the corresponding articles 101 and 103 that were published on Jan. 12, 2020. The daily sentiment scores for a particular entity may be further averaged over a predetermined time period to determine an average sentiment score. The daily sentiment scores may be weighted to place a higher weight on more recent sentiment scores.

Each article may also be tagged with one or more of a plurality of signals 109 and 111. For example, article 101 may be tagged to a supplier issue, where a supplier issue is one of a plurality of predetermined signals related to financial risks. Likewise, article 103 may be tagged to stock rating, where stock rating is one of a plurality of predetermined signals related to financial risks.

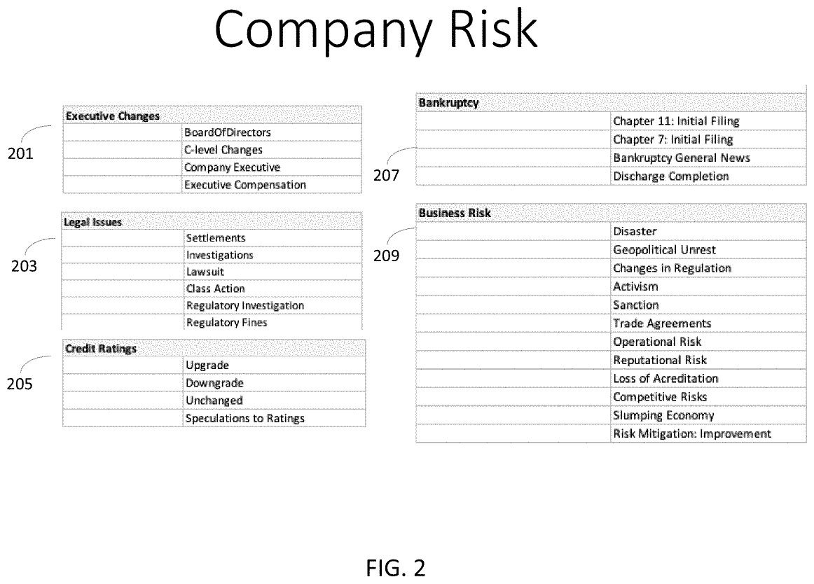

By tagging articles with appropriate signals, risk may be correlated with sentiment to contribute to the definition and calculation of an entity's risk sentiment score. In some embodiments, negative sentiment is highly correlated with emerging risks. FIG. 2 is table of risk signals, in accordance with an example embodiment of the disclosure. Risk signals may be classified at a high level as executive change signals 201, legal Issues signals 203, credit rating signals 205, bankruptcy signals 207, and business risk signals 209. Executive change signals 201 may be tagged to articles regarding board of directors, executive level changes, company executives, and executive compensations. Legal Issues signals 203 may be tagged to articles regarding settlements, investigations, lawsuits, class action suits, regulatory investigations, and regulatory fines. Credit rating signals 205 may be tagged to articles regarding upgrades, downgrades, no changes, and speculations to ratings. Bankruptcy signals 207 may be tagged to articles regarding chapter 11 filing, chapter 7 filing, bankruptcy general news, and discharge completion. Business risk signals 209 may be tagged to articles regarding disaster, geopolitical unrest, regulation changes, activism, sanctions, trade agreements, operational risks, reputational risks, loss of accreditation, competitive risks, slumping economy, and risk mitigation.

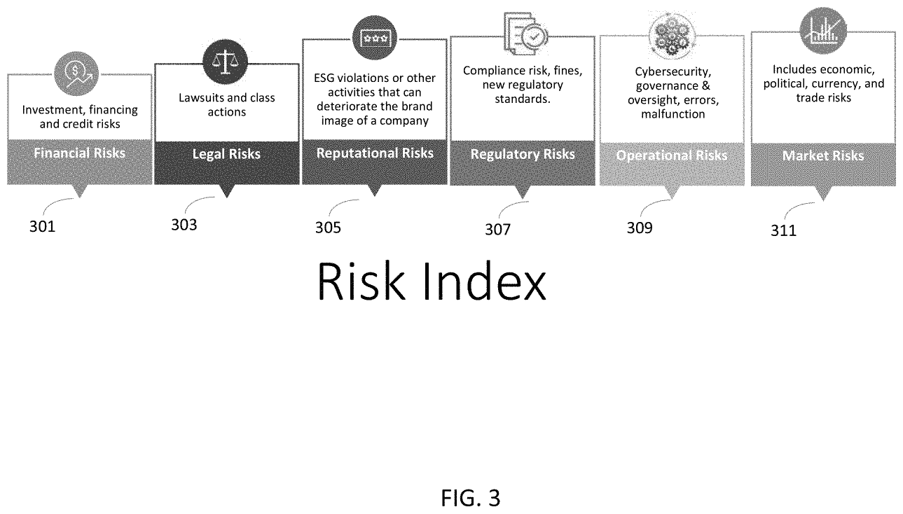

FIG. 3 illustrates the component indices of a risk index, in accordance with another example embodiment of the disclosure. The risk index may be calculated from component indices 301, 303, 305, 307, 309, and 311 derived purely from unstructured data or a combination of structured and unstructured data, analysed on a 24×7×365 basis across new content daily. Natural language processing models may be trained to identify unique risk signals, and sentiment analysis correlated to these risk signals is included in the method contemplated herein for derivation of a company's risk score. Financial risks 301 may include investment, financing and credit risks. Legal risks 303 may include Lawsuits and class actions. Reputational risks 305 may include environmental, social, and governance (“ESG”) violations or other activities that can deteriorate the brand image of a company. Regulatory risks 307 may include compliance risk, fines, and new regulatory standards. Operational risks 309 may include cybersecurity, governance & oversight, errors, and malfunction. Market risks 311 may include economic, political, currency, and trade risks.

A company's risk score may also be adjusted according to predictive insights, such as a likelihood of a credit downgrade, bankruptcy, etc. Predictive analytics using historical event-driven data may be used to assess the likelihood of future events, like bankruptcies, occurring. One or more signals may be associated with a potential risk for bankruptcy. For example, historical event-driven data may indicate that commercial bankruptcies in the US have certain events in common. The potential risk for bankruptcy signal may be tagged by a senior executive change, at least two credit down-grades, a steady decline in company sentiment, a number of significant lawsuits, and secured debt financing. If a company is tagged by a statistically significant number potential risk signals for bankruptcy, the company risk score will be raised.

Example scores include growth, risk, and sentiment. Many scores may be classified as risk and/or growth indicators. Growth and risk may be influenced by, for example, sentiment, average daily number of people at a site, and the number of job openings at a company. Those scores can be broken down even more, number of sales jobs, number of engineering jobs, etc. Furthermore, scores of one company may be influenced by another company's (or an industry's) risk, growth and sentiment scores. For example, the scores of suppliers, supply chain companies, an industry as a whole, partners, customers (particularly key customers) and competitors may all effect a company's risk and growth score.

Not all sub-scores (e.g., other company scores) will be weighted equally. Additionally, weighting may be based on recency where more weight is given to events that were more recent. For seasonal data, weighting may be based on events that occur in a comparative season or month. Weighting may also be controlled by an industry's average, highest peak, lowest valley or moving average for a particular time period. For example, changes and/or patterns in scores associated with a particular day/week/month over a time period for web traffic may have a large influence in growth and risk. Furthermore, scores (e.g., related to a stock price, average salary, number of customers) may predict financial health and revenues or expenses before such status is disclosed (e.g., in a quarterly report, layoff notice or facility expansion).

By tagging articles (or other information or data) with appropriate signals, growth may be correlated with sentiment to define an entity's growth sentiment score. In some embodiments, positive sentiment is highly correlated with growth potential.

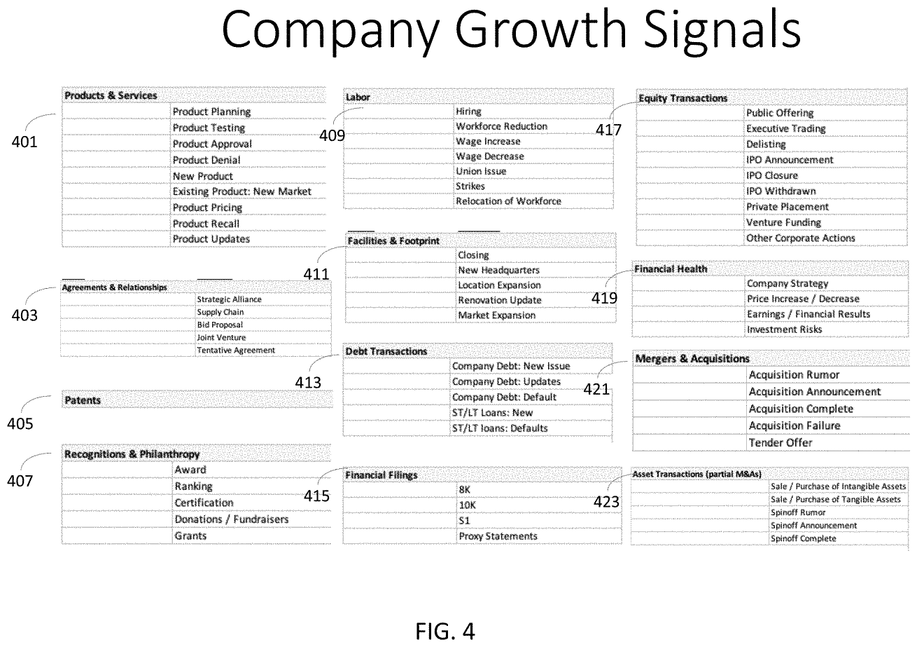

FIG. 4 is table of growth signals, in accordance with an example embodiment of the disclosure. Growth signals may be classified at a high level as products and services signals 401, agreements and relationships signals 403, patent signals 405, recognitions and philanthropy signals 407, labor signals 409, facilities and footprint signals 411, debt transaction signals 413, financial filings signals 415, equity transaction signals 417, financial health signals 419, mergers and acquisitions signals 421, and asset transaction signals 423. Products and services signals 401 may be tagged to articles describing product planning, product testing, product approval, product denial, new product, new markets for existing product, product pricing, product recall, and product updates. Relationships signals 403 may be tagged to articles describing strategic alliance, supply chain, bid proposal, joint ventures, and tentative agreements. Recognitions and philanthropy signals 407 may be tagged to articles describing awards, ranking, certification, donations/fundraisers, and grants. Labor signals 409 may be tagged to articles describing hiring, workforce reduction, wage increases, wage decreases, union issues, strikes, and relocation of workforce. Facilities and footprint signals 411 may be tagged to articles describing closings, new headquarters, location expansion, renovation update, and market expansion. Debt transaction signals 413 may be tagged to articles describing new issues of company debt, new updates to company debt, default on company debt, new short term or long term, and defaults on loans. Financial filings signals 415 may be tagged to articles describing 8K filings, 10K filings, S1 filings, and proxy statements. Equity transaction signals 417 may be tagged to articles describing public offerings, executive trading, delisting, IPO announcements, IPO closure, IPO withdrawn, private placement, venture funding, and other corporate actions. Financial health signals 419 may be tagged to articles describing company strategy, price increase/decrease, earnings/financial results, and investment risks. Mergers and acquisitions signals 421 may be tagged to articles describing acquisition rumors, acquisition announcements, acquisition completion, acquisition failure, and tendering of offers. Asset transaction signals 423 may be tagged to articles describing sale/purchase of intangible assets, sales/purchase of tangible assets, spinoff rumors, spinoff announcements, and spinoff completion.

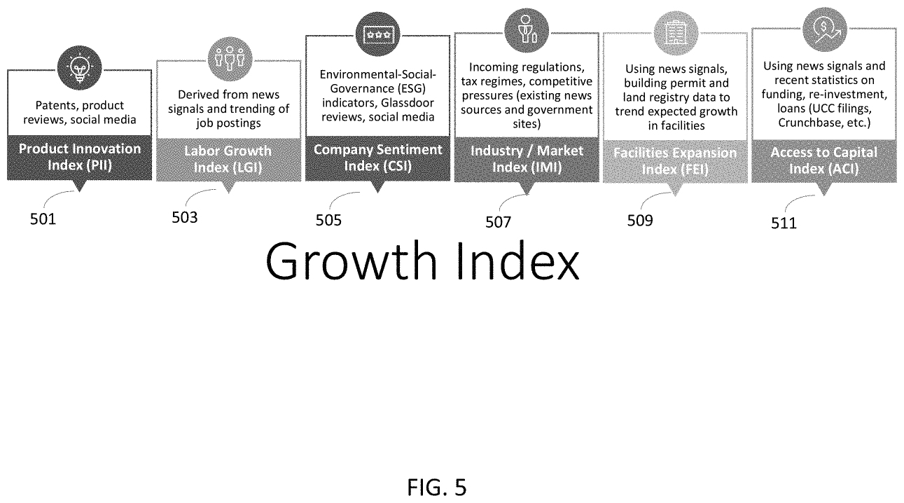

FIG. 5 illustrates the component indices of a growth index, in accordance with another example embodiment of the disclosure. The growth index may be calculated from component indices 501, 503, 505, 507, 509, and 511 derived from unstructured and structured data, analysed on a 24×7×365 basis across new content daily. Natural language processing models may be trained to identify unique growth signals, and sentiment analysis correlated to these growth signals is used to derive a company's growth score. The Product Innovation Index (PII) 501 may include patents, product reviews, and social media. The Labor Growth Index (LGI) 503 may include news signals, Worker Adjustment and Retraining Notifications (WARNs) and trending of job postings. The Company Sentiment Index (CSI) 505 may include ESG indicators, Glassdoor reviews, and social media. The Industry/Market Index (IMI) 507 may include incoming regulations, tax regimes, competitive pressures (existing news sources and government sites). The Facilities Expansion Index (FEI) 509 may include news signals, building permit and land registry data to trend expected growth in facilities. The Access to Capital Index (ACI) 511 may include news signals and recent statistics on funding, re-investment, loans (UCC filings, Crunchbase, etc.).

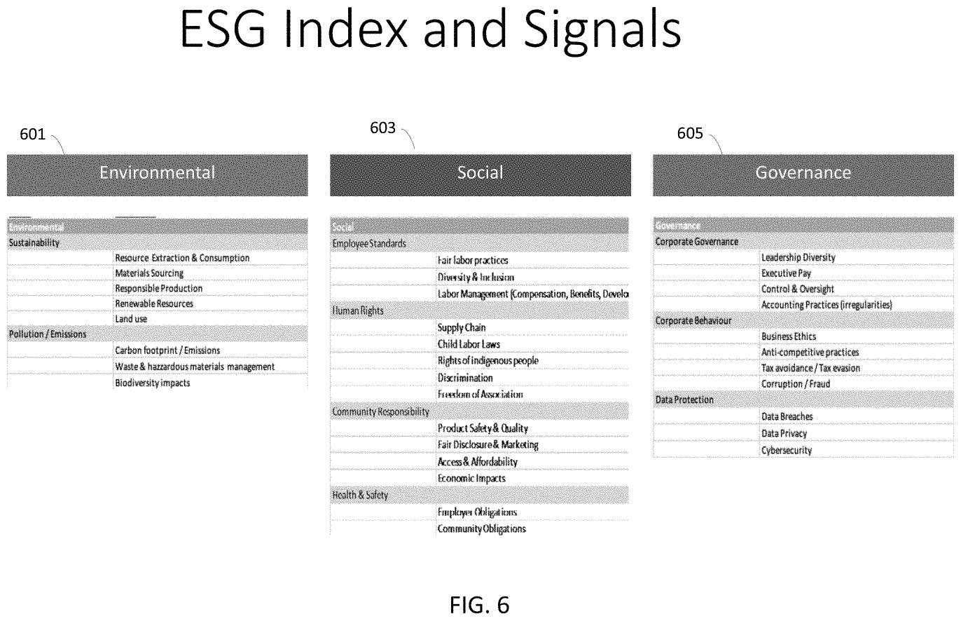

By tagging articles with appropriate signals, ESG (environmental/social/governance) concerns may be correlated with sentiment to define an entity's ESG sentiment score. FIG. 6 illustrates the component indices of an ESG index along with a table of signals corresponding to each ESG component index, in accordance with an example embodiment of the disclosure. ESG signals may be classified at a high level as environmental signals 601, social signals 603, and governance signals 605. Environmental signals 601 may include sustainability signals (e.g., resource extraction and consumption, materials sourcing, responsible production, renewable resources, and land use) and pollution/emissions signals (e.g., carbon foot print/emissions, waste and hazardous materials management, and biodiversity impacts). Social signals 603 include employee standards signals (e.g., fair labor practices, diversity & inclusion, and labor management, such as compensation, benefits, and development), human rights signals (e.g., supply chain, child labor laws, rights of indigenous people, discrimination, and freedom of association), community responsibility signals (e.g., product safety & quality, fair disclosure & marketing, access & affordability, and economic impacts), and health and safety signals (e.g., employer obligations and community obligations). Governance signals 605 may comprise corporate governance signals (e.g., leadership diversity, executive pay, control & oversight, and accounting practices/irregularities), corporate behavior signals (e.g., business ethics, anti-competitive practices, tax avoidance/tax evasion, and corruption/fraud), and data protection signals (e.g., data breaches, data privacy, and cybersecurity).

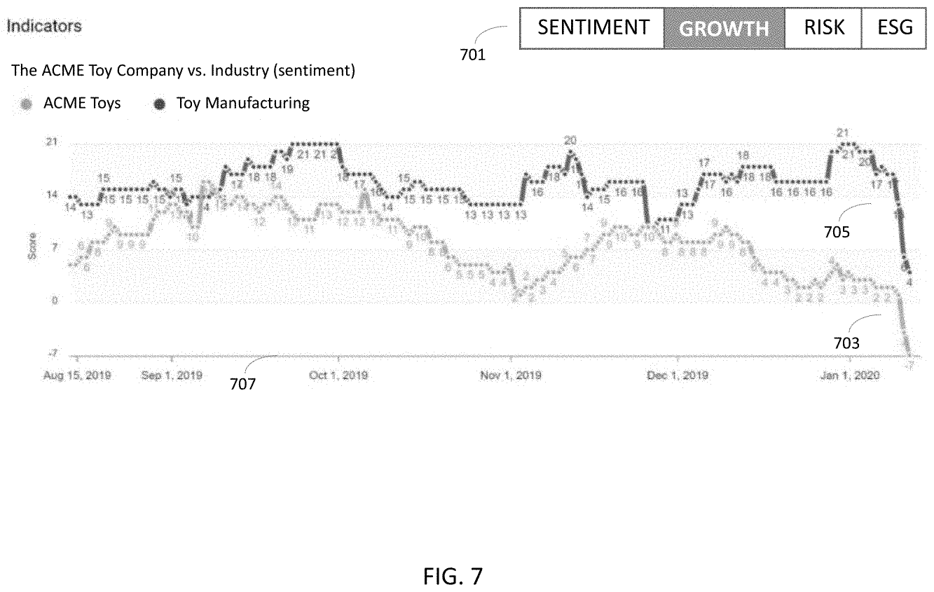

FIG. 7 illustrates a visualization in a system for scoring business indices, in accordance with an example embodiment of the disclosure. A GUI button 701 may select between the sentiment score, the growth score, the risk score, and the ESG score. As illustrated, the growth score 705 for ACME Toy Company is shown over a 90-day rolling window 707. For comparison, the average sentiment of the toy industry can also be displayed for the same time period to benchmark ACME vs. peers in the industry. The raw index scores may be displayed. Alternatively, the index scores may be averaged over a selectable rolling window (e.g., 90 days) using a selectable decay factor to reduce the effect of older scores.

A user may configure a sentiment gauge by company to trigger an alert (e.g., by email) of a change in any index. As FIG. 1 illustrates sentiment scoring for a particular day is based on the analysis of articles. Links to the composite articles may be accessible to enable a user to drill down to see evidence of positive and negative sentiment at an article level.

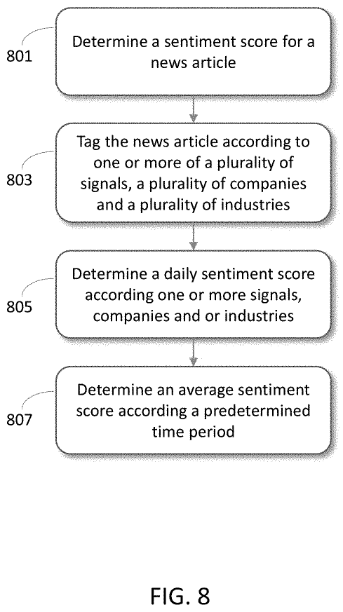

FIG. 8 is a flow diagram of a process for scoring business indices, in accordance with an example embodiment of the disclosure. A method for scoring business indices may comprise determining a sentiment score for an article at 801, tagging the article with an entity (e.g., a company, an industry, or a person) and one or more signals at 803, determining a daily sentiment score according the entity 805, and determining an average sentiment score according the daily sentiment score and a predetermined time period 807. The sentiment score for the article may be based on one or more sentence sentiments. The article may be one of a plurality of articles published on a particular day, and the daily sentiment score may be based on one or more sentiment scores corresponding to one or more of the articles published on the particular day. The one or more signals may comprise signals associated with a risk, an indication of growth, and/or an ESG (environmental/social/governance) concern. These signals may be associated with an index and/or one or more component indices (i.e. “sub-indices”) that forms or form the index. The daily sentiment score may be averaged over time. Signals may also be associated with a potential risk—such as for bankruptcy.

As indicated above and elsewhere in this specification, it is possible for the system to ingest and analyze many forms of information and data. By way of example and not limitation, the system can ingest mobile cell phone geolocation data, analyze it, and correlate it against other ingested data and/or one or more scores the system generates. By way of example and not limitation, the system may be used in a commercial real estate application where a prediction is made by the system of whether a company is going to renew or break a lease for one of its facilities.

By way of example and not limitation, the system may analyze the mobile data to identify important events or benchmarks reflected in other information or data in the system, and compare those to what is reflected in the mobile data, for example, to determine whether there is a lag between an announcement by a company, whether actual behaviors changed as indicated in the announcement, or whether the company is otherwise acting according to the announcement. Such a score may predict unexpected spikes or drops that may be used to influence the risk and growth scores.

A score based on the analysis of mobile data may also predict whether a company will break its lease, not renew its lease, or be looking to expand or change facilities. For example, if a company announces they are ramping up production at a particular plant, but there are no increased volumes at that site, the score may increase risk and decrease growth.

By way of example and not limitation, questions that may be investigated in the comparison of mobile data vs other data in the system may include:

What is the normal work population for the company?
What is the holiday work population for the company?
What is the natural business cycle for the company?
Does the company have a Work from Home (WFM) plan?
When did the company announce that plan?
When did the company institute that plan?
How well did the company follow that plan?
Does the company have a return to work plan?
When did the company announce that plan?
When did the company institute that plan?
How well did the company follow that plan?
Will work at that company be permanently changed?
Will the tenant downsize or reduce footprint?
What work is tied to that specific site?
Will they renew the lease if leased?
Will they break the lease if leased?
Will manufacturing or production be impacted?
If it is, what other companies will be impacted, such as competitors, suppliers, partners, customers?

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, a battery, circuitry or a device is “operable” to perform a function whenever the battery, circuitry or device comprises the necessary hardware and code (if any is necessary) or other elements to perform the function, regardless of whether performance of the function is disabled or not enabled (e.g., by a user-configurable setting, factory trim, configuration, etc.).

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method for scoring business indices, the method comprising:
determining a sentiment score for an article;
tagging the article with an entity and one or more signals of a plurality of signals;
determining a daily sentiment score according the entity; and
determining an average sentiment score according the daily sentiment score and a predetermined time period.

2. The method of claim 1, wherein the sentiment score for the article is based on a plurality of sentence sentiments.

3. The method of claim 1, wherein the article is one of a plurality of articles published on a particular day, and wherein the daily sentiment score is based on a plurality of sentiment scores corresponding to the plurality of articles published on the particular day.

4. The method of claim 1, wherein the entity is one of a company, an industry, and a person.

5. The method of claim 1, wherein the plurality of signals comprise signals associated with a risk.

6. The method of claim 1, wherein the plurality of signals comprise signals associated with an indication of growth.

7. The method of claim 1, wherein the plurality of signals comprise signals associated with one or more of an environmental concern, a social concern, and a governance concern.

8. The method of claim 1, wherein at least one of the plurality of signals is associated with an index and a component index.

9. The method of claim 1, wherein the daily sentiment score is one of a plurality of daily sentiment scores corresponding to the predetermined time period, and wherein the average sentiment score is based on a weighted average of the plurality of daily sentiment scores.

10. The method of claim 1, wherein the plurality of signals comprise signals associated with a potential for bankruptcy.

11. A system for scoring business indices, the system comprising:
a non-transitory computer readable medium having stored thereon software instructions, wherein, when performed by a processor, the software instructions are operable to:
determine a sentiment score for an article;
tag the article with an entity and one or more signals of a plurality of signals;
determine a daily sentiment score according the entity; and
determine an average sentiment score according the daily sentiment score and a predetermined time period.

12. The system of claim 11, wherein the sentiment score for the article is based on a plurality of sentence sentiments.

13. The system of claim 11, wherein the article is one of a plurality of articles published on a particular day, and wherein the daily sentiment score is based on a plurality of sentiment scores corresponding to the plurality of articles published on the particular day.

14. The system of claim 11, wherein the entity is one of a company, an industry, and a person.

15. The system of claim 11, wherein the plurality of signals comprise signals associated with a risk.

16. The system of claim 11, wherein the plurality of signals comprise signals associated with an indication of growth.

17. The system of claim 11, wherein the plurality of signals comprise signals associated with one or more of an environmental concern, a social concern, and a governance concern.

18. The system of claim 11, wherein at least one of the plurality of signals is associated with an index and a component index.

19. The system of claim 11, wherein the daily sentiment score is one of a plurality of daily sentiment scores corresponding to the predetermined time period, and wherein the average sentiment score is based on a weighted average of the plurality of daily sentiment scores.

20. The system of claim 11, wherein the plurality of signals comprise signals associated with a potential for bankruptcy.

21. The method of claim 1, wherein the method comprises:
combining a plurality of articles from a plurality of unique data sources; and
calculating one or more sub-indices according to the combined plurality of articles.

22. The system of claim 11, wherein the software instructions are operable to:
combine a plurality of articles from a plurality of unique data sources; and
calculate one or more sub-indices according to the combined plurality of articles.
